(19) United States
(12) Patent Application Publication
(10) Pub. No.: US 2013/0257207 A1
(43) Pub. Date: Oct. 3, 2013

(54) In-Vehicle Rotating Electrical Machine And Electric Vehicle

(71) Applicants: Kanako Nemoto, Tsuchiura (JP); Hideaki Mori, Yurihonjo (JP); Kenichiro Matsubara, Kasumigaura (JP); Yutaka Matsunobu, Mito (JP)

(72) Inventors: Kanako Nemoto, Tsuchiura (JP); Hideaki Mori, Yurihonjo (JP); Kenichiro Matsubara, Kasumigaura (JP); Yutaka Matsunobu, Mito (JP)

(73) Assignee: HITACHI AUTOMOTIVE SYSTEMS, LTD, Hitachinaka-shi (JP)

(21) Appl. No.: 13/884,988

(22) PCT Filed: Dec. 6, 2011
(86) PCT No.: PCT/JP2011/078165

§ 371 Date: May 13, 2013

(30) Foreign Application Priority Data
Dec. 7, 2010 (JP) 2010-272459

(51) Int. Cl. H02K 5/04

(52) U.S. Cl. CPC H02K 5/04
USPC 310/91

(57) ABSTRACT

An in-vehicle rotating electrical machine 100 includes a stator 1 having a stator core 4 wound by a stator coil 6, a rotor 2 disposed with a rotation gap on an inner peripheral side of the stator core 4, and a flange 5a being a mounting member for mounting the stator 1 on a vehicle 300. The flange 5a is formed such that an axial position of a mounting position with the vehicle 300 is matched with an axial position of a magnetic center of the stator 1.

### TECHNICAL FIELD

The present invention relates to an in-vehicle rotating electrical machine used for travel driving of an electric vehicle, such as HEV or EV, and an electric vehicle mounted with the in-vehicle rotating electrical machine.

### BACKGROUND ART

Rotating electrical machines are often mounted on vehicles and the like, as well as on household appliances and various OA equipments (see PTL 1 and PTL 2). In a rotating electrical machine for vehicle driving, since high power is required and also a rotating range is wide, an excitation frequency of an electromagnetic excitation force greatly changes. Also, for seeking a comfortable environment of vehicle interior, a need for vibration reduction and noise reduction has recently increased. Therefore, a plurality of technologies for reducing vibration and noise from a main body of a rotating electrical machine is being developed.

### CITATION LIST

### Patent Literatures

PTL 1: Japanese Patent Application Laid-Open No. 2008-254668
PTL 2: Japanese Patent Application Laid-Open No. 2000-197290

### SUMMARY OF INVENTION

### Technical Problem

However, as described above, in the in-vehicle rotating electrical machine, the excitation frequency of the electromagnetic excitation force greatly changes since the rotating range is wide, and vibration and noise are easily generated by resonance since the excitation frequency is coincident with a natural frequency of a structure at a specific number of revolutions. For this reason, vibration and noise generated when vibration generated from the rotating electrical machine is transferred to components mounted with the rotating electrical machine, for example, a vehicle or components constituting the vehicle, such as a transmission or a gearbox, is relatively larger than vibration and noise generated in the main body of the rotating electrical machine. Thus, it is necessary to reduce such vibration or noise.

### Solution to Problem

According to a first aspect of the present invention, an in-vehicle rotating electrical machine used for travel driving of an electric vehicle includes: a stator including a stator core wound around a stator winding; a rotor disposed with a rotation gap on an inner peripheral side of the stator core; and a mounting member which mounts the stator on a vehicle, wherein the mounting member is formed such that an axial position of a mounting position with the vehicle is matched with an axial position of a magnetic center of the stator.

According to a second aspect of the present invention, it is preferable that the in-vehicle rotating electrical machine according to the first aspect includes a chassis for the rotating electrical machine, which holds the stator core to be internally enclosed and in which the mounting member is formed on an outer peripheral surface.

According to a third aspect of the present invention, in the in-vehicle rotating electrical machine according to the first aspect, the mounting member is preferably integrally formed on the outer peripheral surface of the stator core.

According to a fourth aspect of the present invention, in the in-vehicle rotating electrical machine according to the third aspect, the mounting member is a press-fit portion which is integrally formed to protrude on the outer peripheral surface of the stator core, and the stator core is preferably mounted on the vehicle side by press-fitting the press-fit portion formed in the stator core into a press-fitted portion of the vehicle side.

According to a fifth aspect of the present invention, in the in-vehicle rotating electrical machine according to any one of the first to fourth aspects, it is preferable that when L is an axial dimension of the stator core and L1 is an axial deviation dimension of the mounting position in a direction of a center of gravity of a composite body including the rotor and a driven body connected to the rotor, the dimension L1 is set such that a position deviation rate Δ=(L1/L)×100 is within ±20%.

According to a sixth aspect of the present invention, an electric vehicle is mounted with the in-vehicle rotating electrical machine of the first aspect as a driving electrical motor.

### Advantageous Effects of Invention

According to the present invention, in the electric vehicle mounted with the in-vehicle rotating electrical machine, reduction of vibration or noise can be achieved.

### BRIEF DESCRIPTION OF DRAWINGS

FIG. 1 is a schematic view illustrating a schematic configuration of an electric vehicle mounted with an in-vehicle rotating electrical machine.

FIG. 2 is a sectional view illustrating a rotating electrical machine 100 received in a gearbox 3.

FIG. 3 is a view illustrating a cross section of the rotating electrical machine 100 with a plurality of rotors 2A and 2B.

FIG. 4 is a view illustrating a rotating electrical machine 1000 when a position of the center of gravity is matched with a mounting position.

FIG. 5 is a view illustrating another example of a case in which a position of the center of gravity is matched with a mounting position.

FIG. 6 is a view showing a simulation result of a frequency response of an average vibration velocity.

FIG. 7 is a view illustrating a relationship between a magnetic center MC and a mounting position F.

FIG. 8 is a view showing simulation results in a case in which a deviation rate Δ is 0%, 20% and 25% and a conventional case.

FIG. 9 is an enlarged view illustrating a peak portion in the vicinity of 5000 [r/min] of FIG. 8.

FIG. 10 is a view illustrating a first modification of the rotating electrical machine 100.

FIG. 11 is a view illustrating a shape of a stator core 4 in the first modification.

FIG. 12 is a view illustrating a second modification of the rotating electrical machine 100.

FIG. 13 is a view illustrating a third modification of the rotating electrical machine 100.

### DESCRIPTION OF EMBODIMENTS

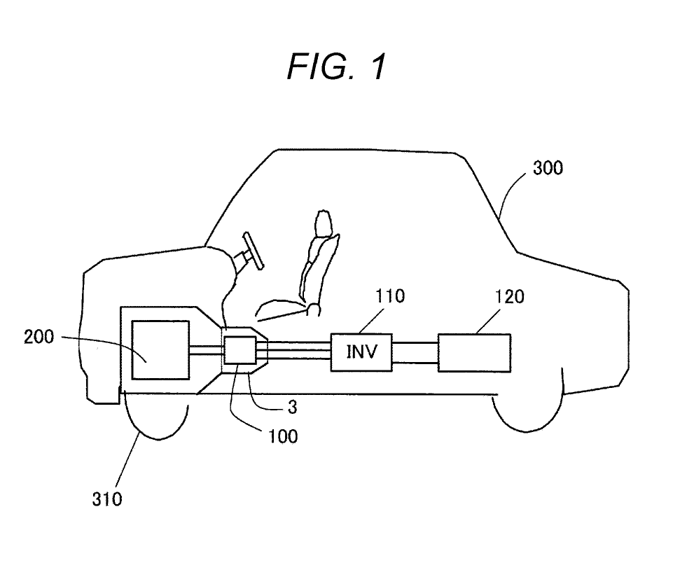

Hereinafter, embodiments of the present invention will be described with reference to the drawings. FIG. 1 is a schematic view illustrating a schematic configuration of a driving unit in an electric vehicle mounted with an in-vehicle rotating electrical machine according to this embodiment. A vehicle 300 is mounted with a rotating electrical machine 100, a gear mechanism 200, an inverter 110, and a battery 120. The electric vehicle illustrated in FIG. 1 is a front-wheel drive vehicle, and the driving force of the rotating electrical machine 100 is transmitted through the gear mechanism 200 to front wheels 310. The rotating electrical machine 100 is received in a gearbox 3 in which the gear mechanism 200 is accommodated. DC (direct current) power of the battery 120 is converted into AC (alternate current) power by the inverter 110, and the AC power is supplied to the rotating electrical machine 100. In the rotating electrical machine 100, for example, a three-phase synchronous motor is used.

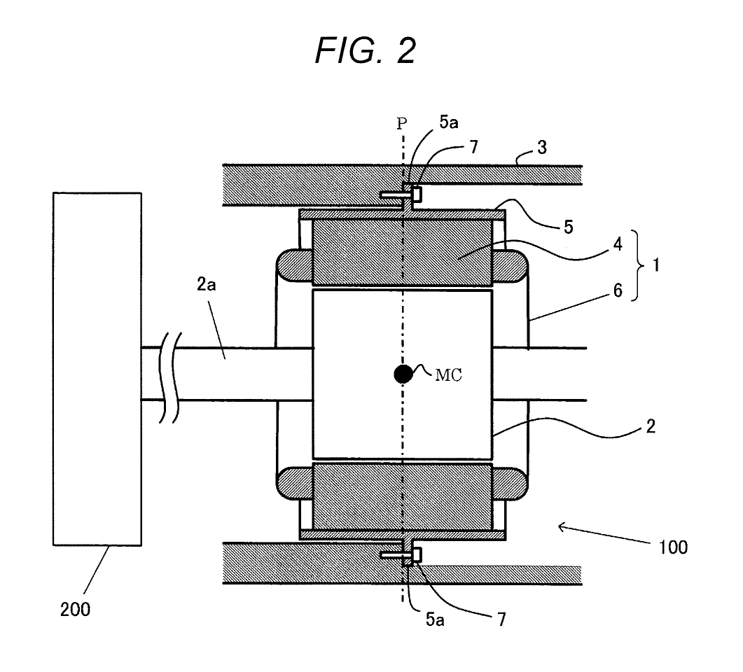

FIG. 2 is a sectional view illustrating an example of the rotating electrical machine 100 received in the gearbox 3. The rotating electrical machine 100 includes a stator 1 and a rotor 2. The stator 1 includes a stator core 4 formed by laminating magnetic steel sheets in an axial direction, and a stator coil 6 wound around the stator core 4. On the inner peripheral side of the stator core 4, the rotor 2 is inserted through a small gap. A rotor shaft 2a extending from side to side in the illustration of the rotor 2 is supported by bearings which are not illustrated. The left rotor shaft 2a (output shaft) is connected to the gear mechanism 200 driven by the rotating electrical machine 100, that is, a driven body as a load.

On the other hand, the stator core 4 is held on the inner peripheral surface of a cylindrical chassis 5. The stator core 4 is shrink-fitted or press-fitted into the inner peripheral surface of the chassis 5. On the outer peripheral surface of the chassis 5, a flange 5a is formed. A plane indicated by dashed-dotted lines is a plane perpendicular to axis, which passes through the magnetic center MC of the stator core 4. The flange 5a is a support portion for fixing the chassis 5 to the gearbox 3, and is fixed to the gearbox 3 by a bolt 7. The gearbox 3 is fixed to the vehicle side. The flange 5a is formed such that an axial position of a flange mounting surface contacting the gearbox 3 is substantially matched with an axial position of the magnetic center MC of the stator core 4.

The magnetic center is defined as two following points.

(a) With regard to the plane perpendicular to the axis, a position where the total force of the electromagnetic excitation forces generated in the stator or the rotor is balanced within the plane

(b) With regard to the axial direction, when assuming that the stator or the rotor is divided into two parts by the plane perpendicular to the axis, a position where the total force of the electromagnetic excitation forces of the axial direction of the stator or the rotor divided into two parts is balanced

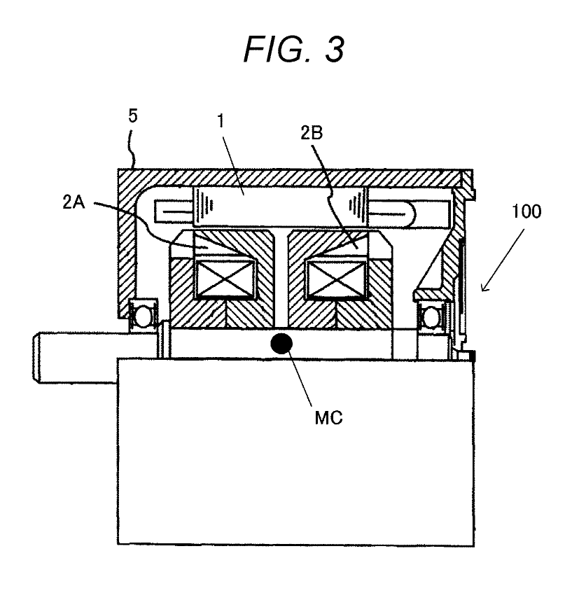

Note that, in a case in which the rotor 2 is configured by a plurality of rotors connected in series, only one plane perpendicular to the axis is defined with respect to the axial range where all of the rotors exist. For example, as illustrated in FIG. 3, in a case in which the rotors 2A and 2B having the same shape are provided to form a mirror image with respect to the plane perpendicular to the axis, which is positioned in the middle of them, the axial position of the magnetic center MC exists within the plane perpendicular to the axis. In this case, a magnetic gap may exist between the two rotors.

Generally, most of the rotating electrical machines are configured such that the magnetic center of the stator and the magnetic center of the rotor are matched with each other, and the magnetic center is positioned in the center of the axial direction (the center of the lamination direction) of the stator 1 (or the rotor 2). Even in the case of the rotating electrical machine 100 illustrated in FIG. 2, the magnetic center is positioned in the center of the axial direction of the stator 1, and the magnetic centers of the stator 1 and the rotor 2 are matched with each other.

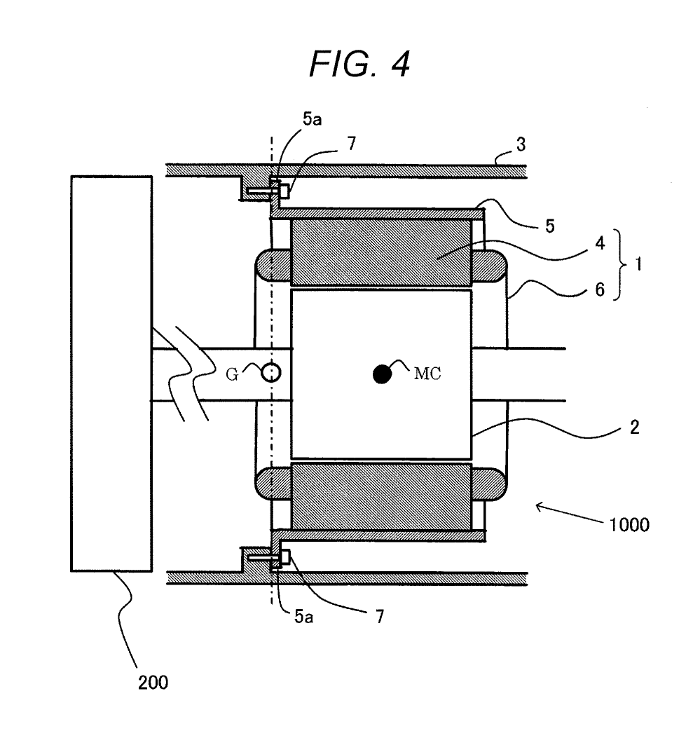

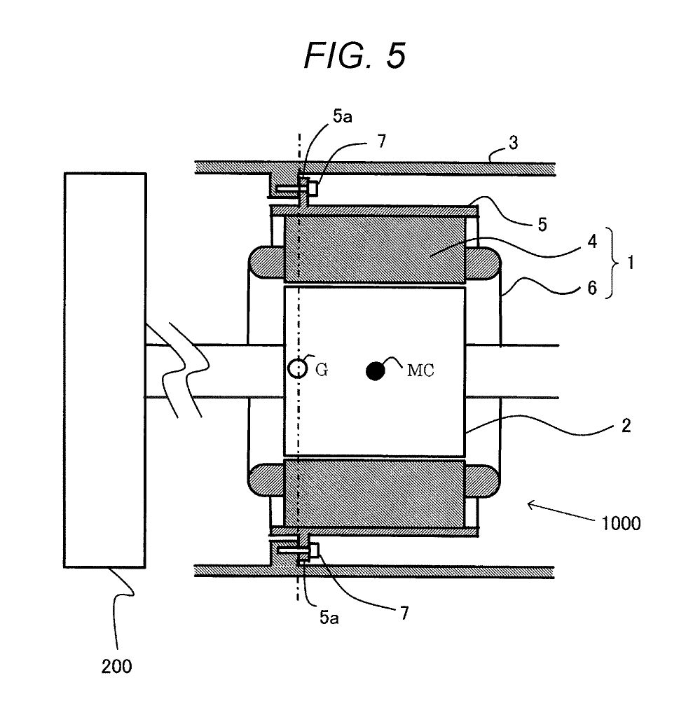

However, a conventional rotating electrical machine 1000, as illustrated in FIGS. 4 and 5, is generally configured such that an axial position of a fixing surface of a flange 5a provided in a chassis 5 is substantially matched with an axial position (indicated by dashed lines) of the center G of gravity of a rotating body provided by combining a driven body connected to a rotor output side (gear mechanism 200 in the present embodiment) and a rotor 2.

In the example illustrated in FIG. 4, the axial position of the center G of gravity is present on the left side (driven body side) rather than the left end face of the rotor 2 or the stator core 4, and the flange 5a is formed on the extreme left of the chassis 5 such that the axial position of the mounting surface is almost matched with the position of the center of gravity. Also, in the example illustrated in FIG. 5, the axial position of the center G of gravity is present on the right side slightly rather than the left end face of the rotor 2 or the stator core 4, and the flange 5a is formed at a position inward from the extreme left of the chassis 5 such that the axial position of the mounting surface is almost matched with the position of the center of gravity.

In the case of the in-vehicle rotating electrical machine, mass and moment may be increased in the driven body side (the gear mechanism 200 side in the present embodiment) with respect to the rotating electrical machine. In such a case, as illustrated in FIG. 5, the axial position of the center G of gravity is close to the end portion of the rotating electrical machine 1000, or, as illustrated in FIG. 4, the axial position of the center G of gravity is out of the range of the rotor 2 or the stator core 4. Also, in a case in which the rotating electrical machine 100 is connected to a transmission, the center G of gravity changes with time, and also, there is no guarantee that the axial position of the center G of gravity exists within a range of a rotor shaft length or a stator shaft length of the rotating electrical machine 1000.

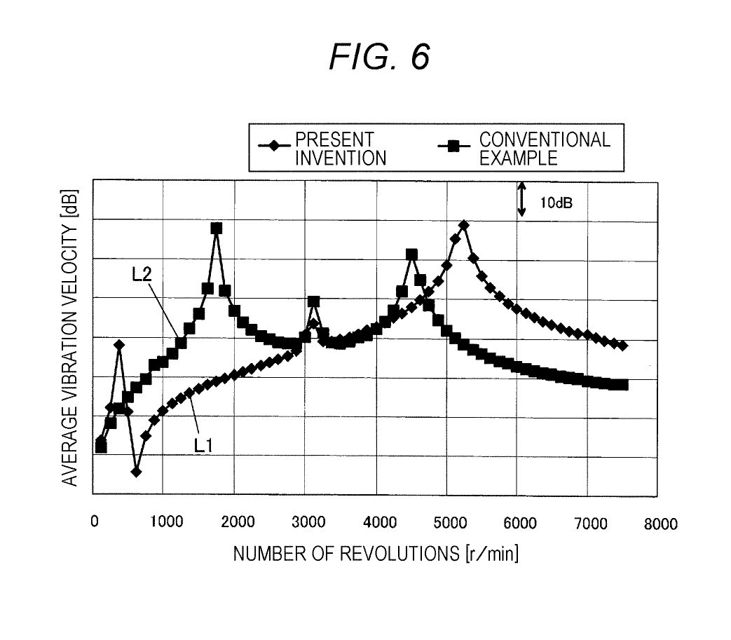

FIG. 6 is a view showing a simulation result on the rotating electrical machines illustrated in FIGS. 2 and 4. That is, FIG. 6 shows the frequency response of the average vibration velocity (average of the vibration velocities of the surfaces of the rotating electrical machines 100 and 1000 and the gearbox 3) when torque ripples having the same amplitude are input to the stator cores 4 of the rotating electrical machine models illustrated in FIGS. 2 and 4. In FIG. 6, a curve L1 is a calculation result on the rotating electrical machine 100 illustrated in FIG. 2, and a curve L2 is a calculation result on the rotating electrical machine 1000 illustrated in FIG. 4.

In all cases of the curves L1 and L2, three peaks appear in the average vibration velocity. In the case of the conventional rotating electrical machine 1000 (curve L2), peaks occur in the vicinity of 2000 [r/min], 3000 [r/min], and 4500 [r/min]. On the other hand, in the case of the rotating electrical machine 100 of FIG. 2 (curve L1), peaks occur in the vicinity of 500 [r/min], 3000 [r/min], and 5000 [r/min]. That is, in relation to the mounting position of the stator core 4 with the vehicle, the axial position of the mounting position and the axial position of the magnetic center MC are almost matched with each other. In this way, the natural frequency of the vibration mode changes. Therefore, the peak in the vicinity of 2000 [r/min] of the curve L2 is shifted to about 500 [r/min] in the curve L1, and the peak in the vicinity of 4500 [r/min] of the curve L2 is shifted to about 5000 [r/min] in the curve L1.

On the lower speed rotation side than the vicinity of 3000 [r/min], the curve L1 of the present embodiment becomes lower in the average vibration velocity as a whole. When comparing the peaks, the average vibration velocity is lowered by about 30 [dB]. The reason for this is that, in the example illustrated in FIG. 2, the magnetic center MC, which is the position where the total force of the electromagnetic excitation forces acts, and the position where the stator 1 is mounted on the vehicle side are almost matched with each other in the axial direction. Therefore, as compared with the case of FIG. 4, an axial distance between the mounting position with the gearbox 3 and the magnetic center MC is shortened, and it can be considered that the moment caused by the electromagnetic excitation force acting on the mounting position can be reduced. As a result, the peak of the low speed rotation side (peak in the vicinity of 500 [r/min]) is reduced in the average vibration velocity by about 30 dB.

In the in-vehicle rotating electrical machine 100, since the start and stop of the vehicle are frequently repeated, on/off of the rotating electrical machine 100 is frequently performed. Also, as the vehicle speed is lower, wind noise or road noise becomes smaller. Therefore, vibration or noise caused by the rotating electrical machine 100 becomes remarkably susceptible. For this reason, in the electric vehicle such as EV or HEV, requirements for reduction of vibration, in particular, during the low speed rotation become strict. Therefore, as in the present embodiment, the ability to significantly reduce the average vibration velocity on the low speed rotation side is the result that meets the requirements for reduction of vibration during the low speed rotation.

Note that, in the calculation result illustrated in FIG. 6, with regard to the peak of the high speed rotation side (peak in the vicinity of 5000 [r/min]), the average vibration velocity is increased by about 7 dB, as compared with the peak in vicinity of 4500 [r/min] of the curve L2. As a result, the peak in the vicinity of 5000 [r/min] is the average vibration velocity peak of almost the same level as the peak in the vicinity of 2000 [r/min] of the conventional case (curve L2).

As described above, as the vehicle speed is faster, noise of the vehicle is greatly affected from other sound sources such as wind noise or road noise. Under circumstances where other noises are generated, it is relatively difficult for human sense to feel noise caused by the rotating electrical machine 100. That is, as the number of revolutions of the rotating electrical machine 100 is increased and thus the vehicle speed is faster, an allowable value with respect to noise caused by vibration of the rotating electrical machine 100 or the gearbox 3 mounted with the same is increased. For this reason, as illustrated in FIG. 6, even when the average vibration velocity on the high speed rotation side is slightly increased as compared with the related art, passengers hardly feel that noise has increased.

As described above, in the present embodiment, when the rotating electrical machine 100 is mounted on the vehicle side, the axial position of the mounting position is almost matched with the axial position of the magnetic center MC of the stator core 4. In this way, the average vibration velocity of the low speed rotation side can be greatly reduced. Since the noise reduction effect is high, quietness can be improved than in the related art.

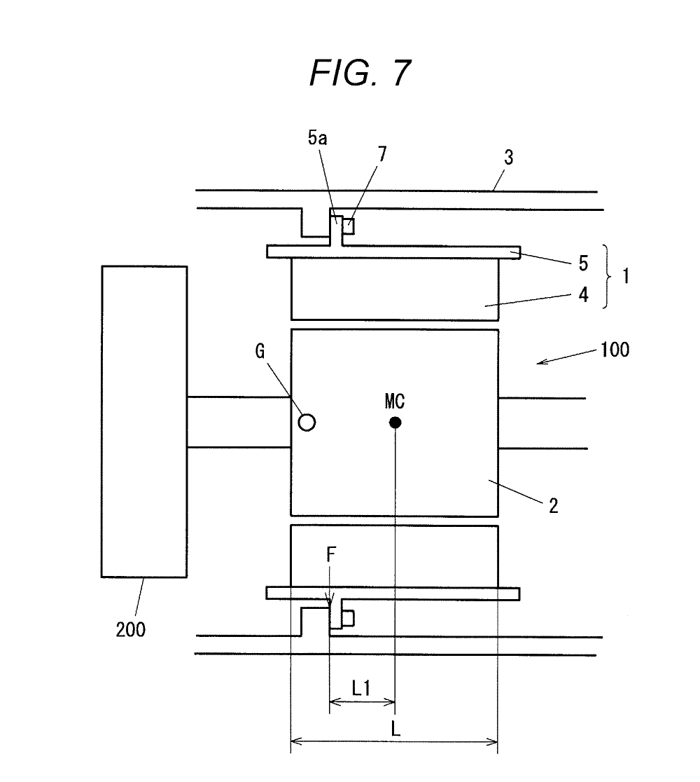

The simulation result illustrated in FIG. 6 was the calculation result when the axial position of the mounting position of the stator side was matched with the axial position of the magnetic center MC. However, both of the axial positions need not be exactly matched with each other, and even when both of the axial positions are slightly mismatched, the noise reduction effect is sufficient. Hereinafter, a case in which the axial position of the mounting position is slightly shifted from the axial position of the magnetic center MC will be described. Herein, it is assumed that the deviation rate Δ(%) of the axial position from the magnetic center MC is expressed as Δ=(L1/L)×100. As illustrated in FIG. 7, L is a lamination thickness (that is, axial dimension) of the stator core 4, and L1 is an axial distance of the mounting position F with reference to the magnetic center MC. As illustrated in FIG. 7, when the mounting position F is disposed on the driven body (gear mechanism 200) side, L1 is set as plus. For example, when the mounting position F is disposed at the left end position of the stator core 4, the deviation rate is Δ=50%. On the contrary, when the mounting position F is disposed at the right end position of the stator core 4, the deviation rate is Δ=−50%.

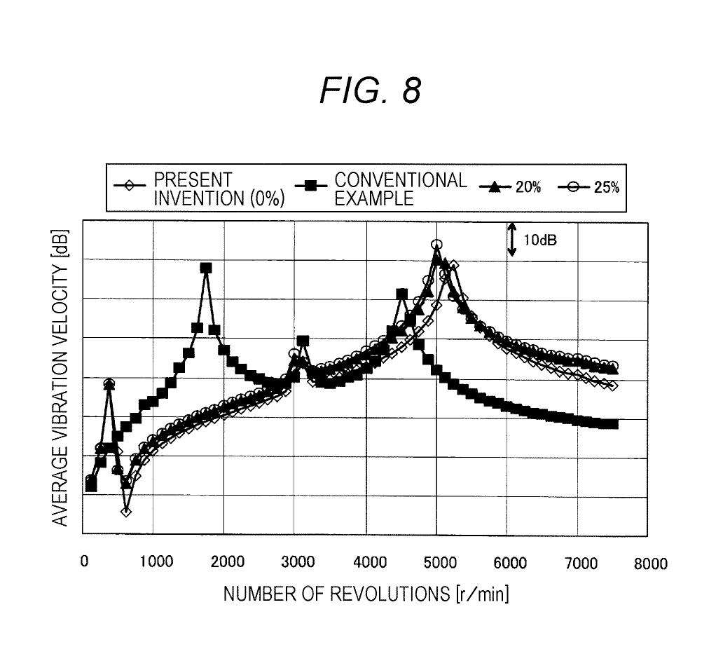

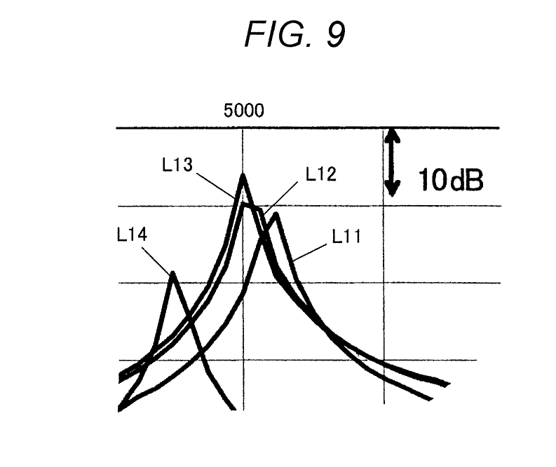

FIG. 8 shows simulation results in the case in which the deviation rate is Δ=0%, 20%, and 25%, and in the case in which the axial position of the mounting is matched with the center G of gravity as in the related art (FIG. 5), and shows the frequency response of the average vibration velocity when torque ripples having the same amplitude are input. Also, FIG. 9 is an enlarged view illustrating a peak portion in the vicinity of 5000 [r/min]. A curve L11 represents a case of Δ=0%, that is, a case of the configuration illustrated in FIG. 2. Curves L12 and L13 represents a case of Δ=20% and a case of 25%, respectively. A curve L14 represents a conventional case in which the axial position of the center G of gravity is matched with the mounting position.

As illustrated in FIG. 8, with regard to the peak in the vicinity of 500 [r/min], all of Δ=0%, 20% and 25% are at almost the same level, and are at almost the same level (difference+3 dB or lower) as the vicinity of 2000 [r/min] of the conventional art. Generally, when the change of the noise level can be detected by human hearing, it is said that 3 dB or more is changed. Also, it is considered that there is a correlation between noise and vibration. Therefore, finally, as long as noise is a problem, an allowable error range is ±3 dB in vibration and noise. Therefore, this is an allowable range.

On the other hand, with regard to the peak in the vicinity of 5000 [r/min], when the deviation rate of the axial position between the mounting position and the magnetic center MC increases, the average vibration velocity peak amplitude tends to increase. In FIGS. 8 and 9, the case in which the deviation rate Δ is 0%, 20%, and 25% is illustrated. However, when calculated in more detail as in the case in which the deviation rate Δ is 0%, 5%, 10%, 15%, 20%, and 25%, the peak value in the vicinity of 5000 [r/min] is 0% (5250 [r/min], −21.1 dB), 5% ([5125 [r/min], −21.1 dB), 10% (5125 [r/min], −17.7 dB), 15% (5125 [r/min], −17.5 dB), 20% (5000 [r/min], −19.8 dB), 25% (5000 [r/min], −15.9 dB). Also, the peak in the vicinity of 2000 [r/min] of the conventional case is −22.1 dB.

That is, in a case in which the deviation rate between the axial position of the mounting position and the axial position of the magnetic center MC is Δ=25%, the peak in the vicinity of 5000 [r/min] is increased in the amplitude of the average vibration velocity peak by about 6 dB or more than the peak level in the vicinity of 2000 [r/min] in the conventional case. Therefore, the allowable range of the deviation rate Δ between the axial position of the mounting position and the axial position of the magnetic center MC can be set to 0 to 20% of the lamination thickness L of the stator core.

Also, in the above-described simulation, a case in which the mounting position F was shifted to the direction of the center of gravity as illustrated in FIG. 7 was examined. However, since the change of vibration as illustrated in FIGS. 8 and 9 is caused by the change of the vibration state of the rotating electrical machine 100 by shifting the mounting position, the same change of vibration also occurs when the mounting position F is shifted in a direction opposite to the direction of the center of gravity. That is, in the range (−20% to 0%) of the deviation rate Δ of the same level as described above, noise or vibration caused by the rotating electrical machine 100 can be reduced. Therefore, in the range where the position deviation rate Δ=(L1/L)×100 is within ±20%, noise or vibration caused by the rotating electrical machine 100 can be reduced.

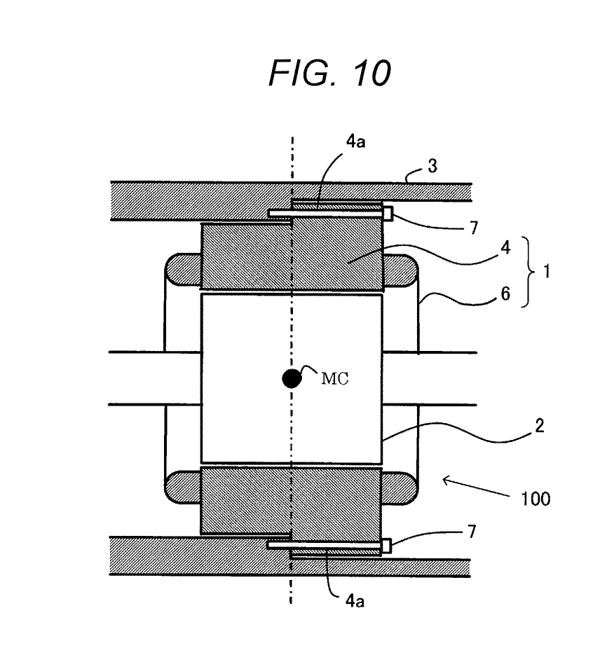

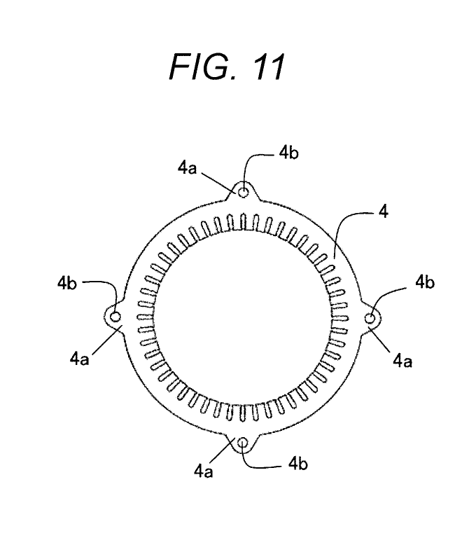

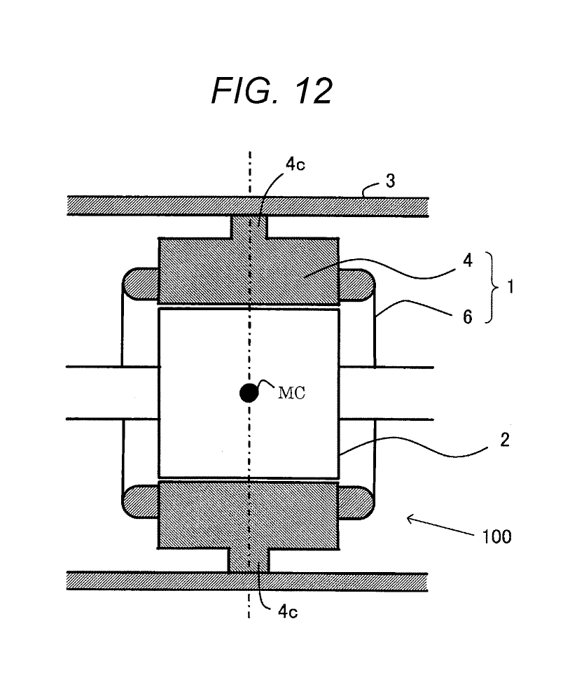

In the example illustrated in FIG. 2, the stator core is held on the inner peripheral surface of the cylindrical chassis 5, and the chassis 5 is mounted on the gearbox 3 fixed to the vehicle. However, as illustrated in FIGS. 10 and 12, the stator core 4 may be directly mounted on the gearbox 3. In the example illustrated in FIG. 10, as illustrated in FIG. 11, a flange portion 4a in which a bolt hole 4b is formed on the outer peripheral surface of the stator core 4 is provided, and the stator core 4 is directly fixed by a bolt such that the end face of the flange portion 4a comes into contact with the gearbox 3. In this case, the position of the end face of the flange portion 4a is the mounting position, and the position of the end face is substantially matched with the axial position of the magnetic center MC of the stator core 4.

On the other hand, in the example illustrated in FIG. 12, the stator core 4 is fixed to the gearbox 3 by press fit. On the outer peripheral surface of the stator core 4, a ring-shaped press-fit portion 4c is formed. In this case, the center portion in the axial direction of the press-fit portion 4c is considered as the mounting position, and the mounting position and the axial position of the magnetic center MC of the stator core 4 are configured to be substantially matched with each other. Also, in FIG. 12, the press-fit portion 4c is formed in a ring shape. However, instead of the entire range of one round of 360 deg, predetermined ranges of a plurality of places may be set as the press-fit portion.

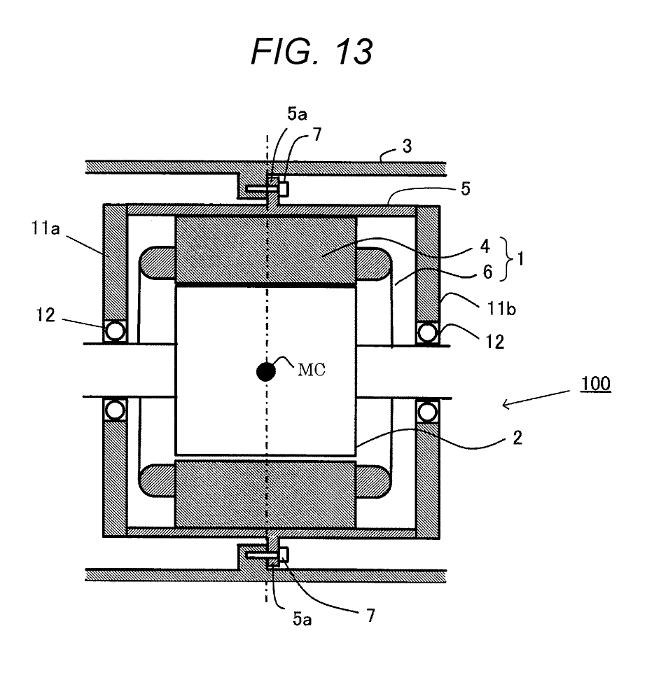

Also, the configuration illustrated in FIG. 13 may be provided. In the case of the rotating electrical machine 100 illustrated in FIG. 2, the rotor 2 is configured to be supported by the bearings provided on the gearbox 3 side. In the configuration illustrated in FIG. 13, as in the general rotating electrical machine, the rotor 2 is supported by bearings 12 disposed in a front bracket 11a and a rear bracket 11b provided in the chassis 5 of the rotating electrical machine 100. On the outer peripheral surface of the chassis 5, a flange 5a for mounting is formed as in the case of the chassis 5 illustrated in FIG. 2, and the axial position of the mounting surface is substantially matched with the axial position of the magnetic center MC of the stator core 4.

As described above, the rotating electrical machine of the present embodiment has the following features.

(1) The rotating electrical machine 100 includes the stator 1 having the stator core 4 wound around the stator winding, the rotor 2 disposed with the rotation gap on the inner peripheral side of the stator core 4, and the mounting member 5a for mounting the stator 1 on the vehicle. The mounting member 5a is formed such that the axial position of the mounting position with the vehicle is matched with the axial position of the magnetic center MC of the stator 1. As a result, noise or vibration caused by the rotating electrical machine 100 can be reduced.

(2) Also, the chassis 5 for the rotating electrical machine, which holds the stator core 4 to be internally enclosed and in which the flange 5a being the mounting member is formed on the outer peripheral surface may be provided. Also, the mounting member 4c may be integrally formed on the outer peripheral surface of the stator core 4. In that case, the mounting member 4c is set as the press-fit portion integrally formed to protrude on the outer peripheral surface of the stator core 4, and the press-fit portion 4c formed in the stator core 4 is press-fit into the gearbox 3 being the press-fitted portion of the vehicle side. In this way, the stator core 4 is mounted on the vehicle side.

(3) Also, when L is the axial dimension of the stator core 4 and L1 is the axial deviation dimension of the mounting position in the direction of the center of gravity of the composite body including the rotor 2 and the driven body 200 connected to the rotor 2, the noise reduction effect can be achieved if the dimension L1 is set such that the position deviation rate Δ=(L1/L)×100 is within ±20%.

(4) By mounting the above-described in-vehicle rotating electrical machine 100 on the electric vehicle as the driving electrical motor, the electric vehicle with smaller noise can be provided.

Also, in the above-described embodiment, the case in which the rotating electrical machine 100 is received in the gearbox 3 has been described, but the present invention is not limited to the gearbox. The present invention can also be applied to a case in which the rotating electrical machine 100 is mounted on the components of the vehicle side (for example, a transmission, an inverter case, or an axle).

The respective above-described embodiments may be used solely or in combination. The effects of the respective embodiments can be achieved solely or together. Also, the present invention is not limited to the embodiments as long as it does not damage the features of the present invention. Other aspects conceivable within the technical spirit of the present invention fall within the scope of the present invention.

The contents of the disclosure of the following basic application whose priority is claimed is hereby incorporated by reference.

Japanese Patent Application No. 2010-272459 (filed on Dec. 7, 2010)

1. An in-vehicle rotating electrical machine used for travel driving of an electric vehicle, comprising:
a stator including a stator core wound around a stator winding;
a rotor disposed with a rotation gap on an inner peripheral side of the stator core; and
a mounting member which mounts the stator on a vehicle,
wherein the mounting member is formed such that an axial position of a mounting position with the vehicle is matched with an axial position of a magnetic center of the stator.

2. The in-vehicle rotating electrical machine according to claim 1, comprising a chassis for the rotating electrical machine, which holds the stator core to be internally enclosed and in which the mounting member is formed on an outer peripheral surface.

3. The in-vehicle rotating electrical machine according to claim 1, wherein the mounting member is integrally formed on the outer peripheral surface of the stator core.

4. The in-vehicle rotating electrical machine according to claim 3, wherein
the mounting member is a press-fit portion which is integrally formed to protrude on the outer peripheral surface of the stator core, and
the stator core is mounted on the vehicle side by press-fitting the press-fit portion formed in the stator core into a press-fitted portion of the vehicle side.

5. The in-vehicle rotating electrical machine according to claim 1, wherein
when L is an axial dimension of the stator core and L1 is an axial deviation dimension of the mounting position in a direction of a center of gravity of a composite body including the rotor and a driven body connected to the rotor,
the dimension L1 is set such that a position deviation rate Δ=(L1/L)×100 is within ±20%.

6. An electric vehicle mounted with the in-vehicle rotating electrical machine according to claim 1 as a driving electrical motor.
